(19) United States
(12) Patent Application Publication
(10) Pub. No.: US 2006/0254845 A1
(43) Pub. Date: Nov. 16, 2006

(54) Apparatus and procedure for the adjustment of a friction shifting element capability

(76) Inventors: Detlef Baasch, Friedrichshafen (DE); Thomas Rosemeier, Meckenbeuren (DE)

Correspondence Address: DAVIS & BUJOLD, P.L.L.C., 112 PLEASANT STREET, CONCORD, NH, 03301, US

(21) Appl. No.: 11/433,818

(22) Filed: May 12, 2006

(30) Foreign Application Priority Data
May 12, 2005 (DE) 10 2005 021 901.2

(51) Int. Cl. B60K 17/34

(52) U.S. Cl. 180/233

(57) ABSTRACT

An activator (8) and a procedure for adjusting the power-transfer capability of a friction based shifting element (k_VA, k_HA_L, k_HA_R), via which a transmission output torque of a vehicle transmission can be conducted in the longitudinal direction of the vehicle to a drivable, transverse, vehicle shaft or in the transverse direction of the vehicle to a wheel of a functioning vehicle axle. An electric motor (10), a gear train (11) functionally associated with the electric motor (10), and a driving-converter (12) situated between the shifting element (k_VA, k_HA_L, k_HA_R) and the gear train (11), by way of which the rotary motion of the electric motor (10) is transformed into a translatory, activation motion for the control of the shifting element (k_VA, k_HA_L, k_HA_R), are all provided in order to vary the power-transfer capability of the shifting element (k_VA, k_HA_L, k_HA_R) within the limits of the control state of the drive-converter (12).

This application claims priority from German Application Serial No. 10 2005 021 901.2 filed May 12, 2005.

### FIELD OF THE INVENTION

The invention concerns an apparatus for first, the adjustment of a capability for power transfer of a friction based shifting element and second, concerns also a procedure for the adjustment of a capability for power transmission of a friction based shifting element.

### BACKGROUND OF THE INVENTION

In the case of drive trains for motor vehicles, as known within the practice, friction based shifting elements are provided. In regard to said drive trains, allowing for an actual, inherent, capability of power transfer for the shifting element, first, an inherent torque in the longitudinal direction of the vehicle, between a drive shaft and a drivable vehicle axle is possible and second, a torque path to a wheel on a transverse axle is available.

The capability for power transfer of shifting elements, which are predominately assembled as disk clutches (hereinafter, “lamella clutches”), is advantageously carried out by means of an electro-mechanical actuator, which is composed of an electric motor, a gear train device connected with said electric motor, and a therewith connected drive-converter to transform the rotational power generation of the electric motor into a activation motion of the shifting element. In this way, the capability for power transfer on the part of a friction shifting element of this kind will be increased, as an activation increases in the closure direction of the shifting element. The closure direction motion is counter to the spring apparatus, which is acting in the opening direction thereof. The movement in the closure direction is brought to bear on the shifting element and can be increased, since the lamellas of a shifting element are increasingly compacted against one another.

Power transfer of the shifting element would be diminished, first, if the compaction of the lamellas of said shifting element were reduced by means of a corresponding electric motor activation of the drive-converter or second, if the electric motor were still, such as without power, then the reduction would be attributed to a spring, designed to act in the opening direction of the shifting element.

Unfortunately, this has the disadvantageous result, that a placement of a shifting element between (1) a gear train output of a differential of a main or differential transmission of a drive train, and (2) a drivable vehicle axis, as well as between (3) an axle-drive and (4) a wheel of a drivable vehicle axle in a stillstand condition of an electric motor. The result is, after a preset time period, no torque can be conducted through a shifting element and in this case, for example, a skipping interval is not available.

A further disadvantage is that, during travel, as to the drive of the vehicle, neither in an acceleration can a motor braking torque be effective nor in “coast-down” can such a motor braking torque function through an open shifting element, which limits the desired, full predefined selection of driving behavior.

Thus, the present invention has the purpose of making available an apparatus and a performance for adjustment of a power transfer capability through a friction shifting element, by means of which both a holding torque of a parking locking apparatus as well as a drive torque or a braking movement of the drive machine of a vehicle on the output drive even in no-current condition of the electric motor.

In accord with the invention, this purpose is achieved first, by an apparatus for the adjustment of a capability for power transfer of a friction operated shifting element and second, by a procedure for adjustment of a capability for power transfer of a friction shifting element.

### SUMMARY OF THE INVENTION

An activator is proposed in conformity with the invention for adjustment of a power transfer capability through a friction operated shifting element. By means of this activator, first, an output torque from the gear drive can be conducted in the longitudinal direction of the vehicle to a transverse axle, second, the output torque can be conducted cross direction of the vehicle to a wheel on a transverse axle. The activator further possesses an electric motor, a gear train, operationally attached to said motor, and a drive-converter placed between the shifting element and the gear train, by means of which the rotary drive of the electric motor is transformed into a translatory movement for activation of the direct control of the shifting element. The power transfer capability of the shifting element varies in proportion to its dependency on the control state of the drive-converter, whereby the control state of the drive-converter is, in turn, dependent upon the drive torque of the electric motor, which torque has been conducted to the converter by means of the gear train. The shifting element is so equipped with a spring element directing force in the opening direction of the shifting element, that the power-transfer capability of the shifting element is reduced, when the motor is without power.

In accord with the invention, an interrupter device is provided, which brings the drive-converter to halt in its active functioning into a predefined control state.

Therewith, in a simple manner and method, assurance can be given, that a power transfer capability of the shifting element can be properly sustained, even when the electric motor is at a stillstand, in order, for instance, to make available a parking lock timer or a drive interval, i.e., a braking interval in the area of the output power of a motor vehicle.

The procedure for the adjustment of a power transfer capability, in accord with the invention, of a friction based shifting element of a drive train for a vehicle, the capability of power transfer thereof depending on a control state of a drive-converter apparatus, which is bound through a gear train to an electric motor, by way of this connection, a rotating drive of the electric motor is transformed into a translatory activation movement for a shifting element, offers advantageously the possibility, of adjusting the power transfer of the shifting apparatus to a predetermined value by means of a non-activated electric motor.

To this end, the drive-converter apparatus, in a case of a non-activated electric motor, is held by means of a controllable halt demand from a control apparatus in a condition which is dependent upon the operational state of the vehicle control status.

In one advantageous variance of the invented procedure, provision has been made, that a delay apparatus is first activated to proceed to a first point of time at which the shifting element has attained a power transfer capability necessary for the actual operational condition of the vehicle, whereby previously, the power transfer capability of the shifting element, based on an actual value of the power transfer capability, was changed through an electric motor related control of the drive-converter or by off-current shifting of the electric motor and subsequently on the actual adjusted value of the activator to the halting of the drive-converter direction for the stopping of the drive-converter in a predetermined condition.

### BRIEF DESCRIPTION OF THE DRAWINGS

The invention will now be described, by way of example, with reference to the accompanying drawings in which:

FIG. 1 is a basic schematic presentation of a part of a drive train of a vehicle; and

FIG. 2 is an actuator for adjustment of a power transfer capability of a friction based shifting element in a basic schematic presentation.

### DETAILED DESCRIPTION OF THE INVENTION

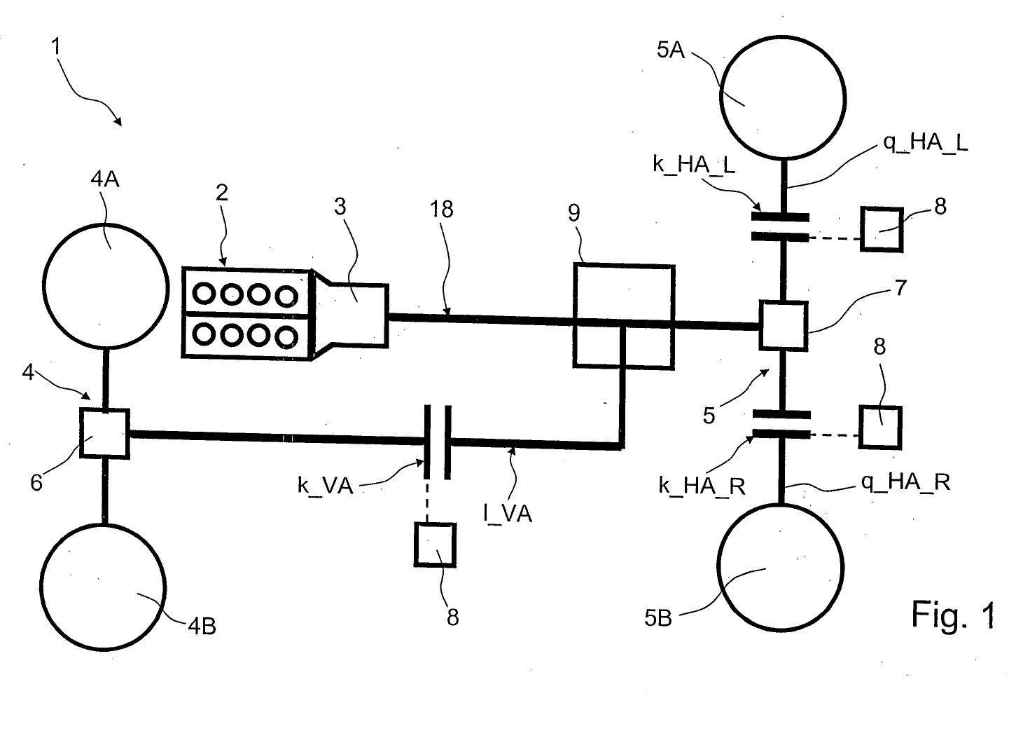

FIG. 1 shows a drive train 1 of a 4-wheel drive type vehicle in a simplified schematic illustration. The drive train 1 incorporates one drive assembly 2 and a principal transmission 3, which can be a standard transmission as known in the practice. The drive assembly 2, as shown in the FIG. 1 embodiment of the drive train 1, can be an internal combustion engine or in a case of exploiting a development, can also be an electric motor.

Between the principal transmission 3, which makes available different gear ratios, and a first, power carrying shaft 4, transversely disposed in the vehicle, which shaft, in a known manner, has bound on each end at least one wheel 4A, 4B and possesses a first clutch k_VA in a longitudinally directed string section l_HA. The first clutch K_VA is located between the principal transmission 3 and a device 6, which serves to compensate the different speeds of rotation of the wheels 4A and 4B rotationally affixed on the first transverse axle 4 of the vehicle. With this arrangement, the device 6 is obviously a known differential drive train.

Additionally, between an axle gear drive 7, by means of which a part of the driving torque of the motor 2 is diverted in the direction of a second, transversely disposed axle 5 and is thus conducted to two axle-end mounted wheels, namely 5A, 5B. Also, respectively to each of the wheels 5A, 5B of the second transverse axle 5 of the vehicle, is to be found, respectively, a second and third clutch k_HA_L and k_HA_R, each respectively in the transverse axle sections, q_HA_L and q_HA_R.

In regard to the differential gearing 6, the possibility exists, of allowing the wheels 4A and 4B of the first transverse axle 4 to be driven, independently of one another, in accord with the different travel length of the left or right curved path and consequently at correspondingly different speeds of rotation, whereby the drive torque can be symmetrically, and hence yaw-free, apportioned between the wheels 4A and 4B of the first transverse axle 4.

Conversely thereto, the transverse apportionment of the drive torque of the motor 2 conducted through the second transverse axle 5, is carried out by means of the variably adjustable power transfer capability of the two clutches k_HA_L and k_HA_R, whereby, advantageously, one of the two clutches k_HA_L and k_HA_R runs in a synchronous state and the other clutch k_HA_R and k_HA_L is allowed to slip. As this occurs, considering the power transfer capability of the slipping clutch k_HA_L and k_HA_R, of the second transverse axle 5, a degree of cross-apportionment of 0% to 100% of that part of the drive torque allotted to second transverse axle 5 can be attained, this being relative to the two wheels 5A or 5B.

In this state of the operation, the degree of cross apportionment with the control of the second clutch k_HA_L and the third clutch k_HA_R conforms sufficiently enough, so that the total portion of the torque, which is conducted to the shaft 5, is received by each of the wheels 5A or 5B in an amount up to 100%, which appears as feedback to the synchronously driven clutch k_HA_R or k_HA_L, if the respective other clutch k_HA_L (or k_HA_R of the cross connection string q_HA_L and q_HA_R is accordingly receiving a correspondingly reduced power transfer capability, of such magnitude, that by this clutch, no torque would be transferred.

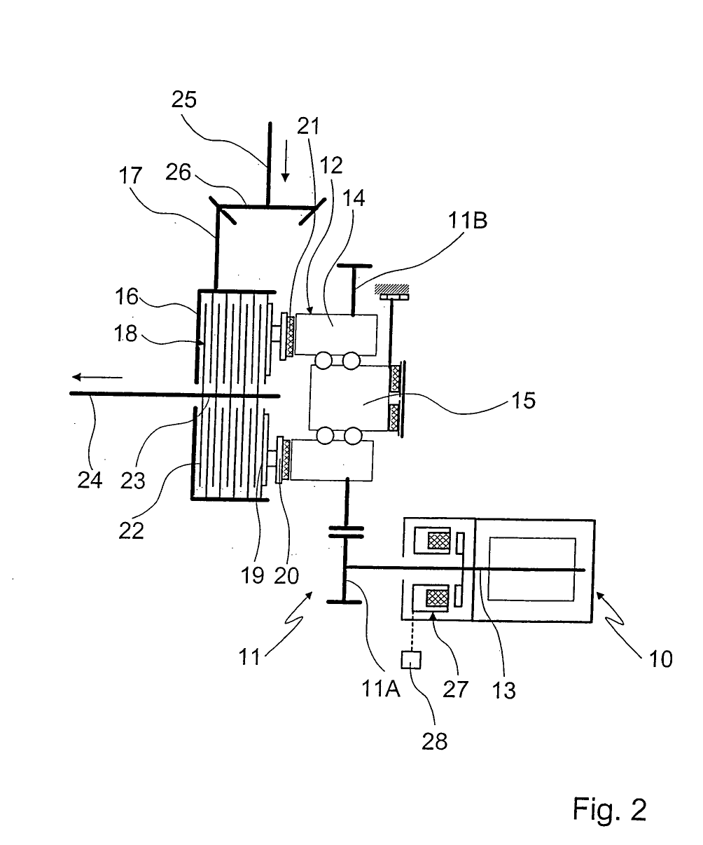

The three clutches k_VA, k_HA_L and k_HA_R of the drive train 1 are predominately designed as controlling and regulating, friction based, lamella clutches, the power transfer capabilities of which clutches are respectively adjustable through the actuator 8 as seen in FIG. 2 and which in FIG. 1 are seen, very schematically, as placed on the output side of a differential output 9. With the three clutches k_VA, k_HA_L and k_HA_R, the possibility exists, of apportioning a drive torque of the motor 2 (or of transmission 3) in a variable fashion and as required upon need between the two drivable transverse axles 4, 5.

The actuator 8, as presented in detail in FIG. 2, presents an apparatus for the adjustment of a power transfer capability of a friction based shifting elements. The shifting elements comprise the first clutch k_VA, the second clutch k_HA_L or the third clutch k_HA_R. In this arrangement is predominately to be attributed to each of the clutches k_VA, k_HA_L or k_HA_R respectively, an actuator 8 as shown in the presented design diagram of FIG. 2, in order to be able to adjust the power transfer capability with full consideration of the actual operational condition of a vehicle.

The actuator 8, for the adjustment of the power transfer capability of a shifting element, possesses, importantly, an electric motor 10, a gear train 11 operationally connected to said electric motor, and, between a shifting element, k_VA, k_HA_L or k_HA_R and the gear train 11, is placed a drive-converter 12. By way of the drive-converter 12, a rotating movement of the electric motor 10 can be transformed into a translatory, activating motion for the control of a shifting element k_VA, k_HA_L or k_HA_R.

The gear train 11 is generally designed as a spur gear stage, whereby the gear train 11, in the case of another embodiment, can also be realized as a planetary gearset or another appropriate gearing combination.

A first spur gear 11A of the gear train 11 is presently bound rotationally fast with a drive shaft 13 of the electric motor 10 and meshes with a second spur gear 11B, which, in turn, is bound rotationally fast with a spindle nut in the conventional spindle assembly, so that a rotational movement of the second gear 11B is directly transferred to the spindle nut 14. The spindle nut 14 is designed to be rotational and fixed in its axial direction.

The spindle and nut combination and the extent of spindle winding are, in the present invention, so designed, that the spindle nut 14, during closure of a shifting element k_VA, k_HA_L and/or k_HA_R possesses the same direction of rotation as would one with a outer lamella carrier 16 of the shifting elements depicted in FIG. 2, namely bevel gear 17, bound to k_VA, k_HA_L and/or k_HA_R. In this way a time interval occurs, because of friction forces entering between the spindle nut 14 and the shifting element k_VA, k_HA_L and/or k_HA_R, and reacts favorably on the closing procedure of the shifting elements.

The above described holding-moments arise from the fact, that between a lamella packet 18 of the shifting elements k_VA, k_HA_L and/or k_HA_R and the spindle nut 14, a pressure plate 20 is provided, rotationally-fast bound with one of the outer lamellas 19 proximal to the spindle nut 14 which, in operation of the drive train 1, rotates with the same rotational speed as the outer lamella carrier 16. The spindle nut 14 of the drive-converter 12, upon a closure procedure of the shifting element k_VA, k_HA_L and/or k_HA_R, moves in the direction of the pressure plate 20, so that friction increases itself between the pressure plate 20 and the spindle nut 14 with a steadily increasing force as the spindle nut 14 moves in this direction and the preset holding moment supports a rotational motion of the spindle nut 14 as well as reinforcing a closure procedure of the shifting elements k_VA, k_HA_L and/or k_HA_R. So that it may also be brought about, that a torque produced by the electric motor 10 during a closure of the shifting elements k_VA, k_HA_L and/or k_HA_R, be reduced in comparison to a closure procedure of a shifting element, namely k_VA, k_HA_L and/or k_HA_R, during which the pressure plate 20 and the spindle nut 14 are driven in different directions of rotary travel.

Between the pressure plate 20 and the spindle nut 14, in the present embodiment, an axial bearing apparatus 21 is provided, so that friction forces between the spindle nut 14 and the pressure plate 20 are reduced. With increasing axial displacement of the spindle nut 14, during the closure procedure of the shifting elements k_VA, k_HA_L and/or k_HA_R, the pressure plate 20 is moved against the lamella-packet 18.

The lamella-packet 18 consists of the outer lamellas 19 and the inner lamellas 22, whereby the inner lamellas 22, bound to an inner lamella-carrier 23 are secured in a fixed, rotatable manner, and are slidable in an axial direction on the output drive shaft 24. The outside lamellas 19, bound with the outside lamella-carrier 16, are rotatably fixed and slidable in an axial direction on the output drive shaft 24. The inner lamella-carrier 23 is rotatably fixed, but not connected in a slidable manner with the drive shaft 24, whereby the pressure plate 20, by means of a spring apparatus on the inner lamella-carrier 23 functioning as a disk-spring (and not further described) is forced counter to the closure direction of the shifting elements k_VA, k_HA_L and/or k_HA_R. Therewith the pressure plate 20, during an opening phase of the shifting elements k_VA, k_HA_L and/or k_HA_R, by which the spindle nut 14 is caused to depart from the shifting element, being displaced by the spring apparatus in the direction of the drive-converter 12, whereby, the power transfer capability of the shifting element is decreased, or completely removed, in accord with the degree of opening of the shifting element.

We now consider the adjusted power transfer capability of the shifting elements k_VA, k_HA_L and/or k_HA_R by means of a predetermined control of the electromotor 10. A part of the drive torque, which stands in operational connection with the transmission output of the differential 9, is transferred by means of a drive shaft 25, which stands in operational contact with transmission output by another bevel gear 26, the bevel gear 17 and the shifting element onto the output shaft 24.

This means, that the power transfer capability of the shifting element k_VA, k_HA_L and/or k_HA_R in dependency of a control state of the drive-converter 12 varies and the control state of the drive-converter 12 stands in dependency of the drive torque of the electric motor 10, which torque is conducted by means of the gear train 11 to the drive-converter 12. Additionally, the arrangement of the spring apparatus leads the arrangement of the shifting element k_VA, k_HA_L and/or k_HA_R in the opening direction, to a state wherein the power transfer capability of the shifting element is reduced, when the electric motor is not energized. The effect of this last named fact has the result, that the shifting element k_VA, k_HA_L and/or k_HA_R is completely opened by the spring action and the vehicle transverse drive shaft 4 or the wheels 5A and 5B of the vehicle transverse axle 5 is completely disassociated from drive side of the drive train 1.

However, since this, in certain situations of the operation of a vehicle, is not desirable, in the area of the drive shaft 13 of the electric motor 10 is provided an interrupter device 27 for halting, which retains the drive-converter 12 in the active condition for a predetermined control dwell period. The interrupter device 27 is primarily designed as an electromagnetic brake, which, when deprived of current, closes and the drive shaft 13 of the electric motor is arrested from rotation.

Therewith, the possibility arises, that the shifting element k_VA, k_HA_L and/or k_HA_R, by means of the activation of the interrupter device 27, when no current is supplied to the motor 10 and, counter to the action of the spring arrangement, can be provided with such a power transfer capability that a holding moment of an active parking lock apparatus becomes active in the area of the main transmission 3, that is to say, through the sequence of the differential 9, the vehicle transverse axle 4 or 5 and the cross connections q_HA_R and q_HA_L.

Moreover, the possibility also exists, during an operative situation of the vehicle, and again when the motor 10 is deprived of current, due to power failure of the utility network, or a functional breakdown of the electric motor 10 itself, and on this account is not available for service, that the shifting element k_VA, k_HA_L and/or k_HA_R be subjected to the existing, power transfer associated, capability. In this case, it would be to advantage to be able to conduct such a torque, which matches the actual driving situation through the shifting element k_VA in the direction of the vehicle transverse axle 4, or by means of the shifting element k_HA_L and k_HA_R to the wheels 5A and 5B of the vehicle.

Giving consideration to the respective, present application cases, the control of the shifting elements k_VA or k_HA_L and k_HA_R, for example upon the imposition of the parking-block, is not immediately deactivated. Much more, the shifting elements k_VA, k_HA_L and/or k_HA_R, by means of a specific electric motor sided control are furnished with a desirable power-transfer capability and the drive-converter 12 subsequently held by the interrupter device 27 in the actual control state.

The interrupter device 27, employed at least for the above holding action, has the capacity, that by means of being provided in a further, advantageous formulation, of serving as a shape-fit friction source is the area of the drive shaft 13 of the electric motor 10, or as a rotor of the electric motor 10, or again in the area of the transmission 11, or the drive-converter 12. Thus the possibility is created of stopping the equipment by frictional means, which frictional means, in an active state of the equipment, comprises a pin for the stopping action, which pin penetrates a boring in the drive shaft 13 of the electric motor 10. Moreover the possibility also exists, of bringing the pin into contact with a complementary apparatus of the rotor of the electric motor 10 or in end-to-end contact with the toothing of the gears 11A or 11B of the gear train 11.

In order to provide adjustment of the power-transfer capability, obviously it is within the competency of the expert to bring the equipment to a halt at actuator 8, which actuator is designed to coact with shifting element k_VA, in order to be able to make available the parking lock torque, which is in the area of the wheels 4A and 4B, which, in the present embodiment, as forward axle designed vehicle axle 4, while the two shifting elements k_HA_L and k_HA_R in the area of the rear axle serving vehicle shaft 5 fully opened and the parking lock moment of the parking lock apparatus in the area of the wheels 5A and 5B of the vehicle axle 5 is not supportable.

Deviating from the above, the possibility also exists, that actuator 8 is only built to regulate the stopping of the shifting elements k_HA_L and k_HA_R with an interrupter device 27, and respectively, with a motor devoid of operating current and this can only be realized with a power-transfer capability which is dependent upon operational condition. The embodiment carrying these conditions, in comparison to the last described arrangement above, wherein the actuator 8 is adapted to furnish the control for the shifting element k_VA with the interrupter device 27 and the parking-lock, by means of differential gear train (which is converted to a 4-differential gear train) is conducted to the two wheels 4A, 4B, offers the advantage that the vehicle, even on a sharp slope, cannot roll away of itself, if one of the wheels 5A, 5B stands on a substrate with a non-activated brake, even if the substrate exhibits a very low frictional resistance. This arises from an independent blocking of the wheels 5A and 5B against the principal transmission 3, i.e., against the following differential 9, from each of the wheels the full parking-lock torque is supportable, in opposition to a differential, in the case of which a wheel torque, can be totally transferred to a wheel standing in next lower frictional value.

The parking-lock torque is maintained by the activated interrupter device 27 for the holding of the drive-converter 12 in a pre-specified control condition concerning the clutches k_HA_L and k_HA_R in this way, not by means of a shape fit closure in the form of toothing of a differential, but rather by a transferred friction closure and where the wheels 5A and 5B are concerned, the vehicle trans-axle 5 is supported.

In order to be able to confirm that an operationally consistent power transfer capability is assured during a driving period of a vehicle for the shifting elements k_VA, k_HA_L, or k_HA_R, even during a functional dropout of the electric motor control thereof, provision has been made, that interrupter device 27 closes with a preset delay, for the purpose of halting the drive-converter 12 in an actual control condition with consideration given to functioning of time control member 28, which is here augmented by an electronic timer activated at the instant of failure of the electric motor 10. In this way, the shifting elements k_VA, k_HA_L, or k_HA_R, respectively, can be placed in dependency of the actual operational condition of the drive train 1, that is, of the vehicle continuous shutdown procedure, and therewith can be considered to possess an available defined power transfer competency. The time related, delayed control of the interrupter device 27 at the stopping operation, for example, is by means of a central drive-dynamical converter 12 of the vehicle, coacting with the power-transfer capability of the shifting elements k_VA, k_HA_L and/or k_HA_R effective at the dropout point of the electric motor 10 and a opening run of time of the shifting elements during the non-connection of the electric motor 10.

In regard to the arrangement of the interrupter device 27 for the stopping of the drive-converter 12, in a defined state of control in the area of the electric motor 10, the emanating stopping torques in the comparison to an arrangement of the interrupter device 27 for stopping in the area of the drive-converter 12 reduced, since the ratio of the transmission gear train (transmission) 11 in the case of the last named arrangement is not useable.

Alternative to the embodiment of the drive-converter 12, depicted in FIG. 2, it is possible, by means of a not further described embodiment of the actuator 8, that the drive-converter be converted to a ball-ramp system or the like, in order that the rotational drive motion of the electric motor 10 is able to be transformed into a linear, activation motion for the shifting element k_VA, k_HA_L and k_HA_R.

Advantageously, the interrupter device 27 is activated to stop in a situation of loss of power. When this happens, it is assured, that a rotational movement in the area of the actuator 8 for the adjustment of a power-transfer capability of a friction based shifting element both by an non-shifted vehicle as well as in the case of a power failure would be safely prevented in the vehicle.

Alternatively or additionally to the interrupter device 27 for the stopping of the drive-converter 12 in a predetermined control state, provision can be made, that the drive shaft 24 of the actuator 8, in accord with FIG. 2, which, optionally is bound to the quadric-differential 6 of the vehicle transverse axle 4 or to the wheel 5A, 5B of the vehicle transverse axle 5, during an unpowered electric motor 10 by way of a shape fit is turn-fast connected, so that the parking-lock apparatus in the area of the main transmission 3 or the differential 9 is obsolete. The shape fit is able, advantageously to serve as an electromechanical or by means of another appropriate control cam, which drops into in a corresponding pickup direction of the output shaft 24 during a still electric motor 10.

### Reference Numerals

| | |
|---|---|
| 1 | drive train |
| 2 | motor, fuel or electric |
| 3 | principle transmission |
| 4 | first vehicle axle |
| 4A, B | wheels on first vehicle axle |
| 5 | second vehicle axle |
| 5A, B | wheels on second vehicle axle |
| 6 | differential gearing |
| 7 | axle gear drive |
| 8 | actuator, apparatus |
| 9 | differential |
| 10 | electric motor |
| 11 | gear train |
| 11A | first clutch, shifting element |
| 11B | second clutch, shifting element |
| 12 | drive-converter |
| 13 | drive shaft |
| 14 | spindle nut |
| 15 | spindle |
| 16 | outside lamella carrier |
| 17 | bevel gear |
| 18 | lamella packet |
| 19 | outside lamella |
| 20 | pressure plate |
| 21 | axial bearing apparatus |
| 22 | inner lamellas |
| 23 | inner lamella carrier |
| 24 | drive shaft to actuator |
| 25 | drive shaft to actuator |
| 26 | additional bevel gear |
| 27 | power interrupt device |
| 28 | timer for element motor |
| k_VA | first clutch, shifting element |
| k_HA_L | second clutch, shifting element |
| k_HA_R | third clutch, shifting element |
| l_VA | longitudinal differential string |
| 1_HA_L | transverse differential string |
| 1_HA_R | transverse different string |

1-12. (canceled)

13. An apparatus for adjusting power transfer capability of a friction shifting element (k_VA, k_HA_L, k_HA_R), the shifting element conducting output torque of a transmission (3, 9) of a motor vehicle in one of a longitudinal direction of the motor vehicle to a driven vehicle axle (4) and in a direction transverse to a wheel (5A, 5B) of a drivable vehicle axle (5), the apparatus comprising:
an electric motor (10) operationally connected with a gear train transmission (11);
a drive-converter (12) placed between the friction shifting element (k_VA, k_HA_L, k_HA_R) and the transmission (11) to transform rotary drive of the electric motor (10) into a translatory activation movement for controlling the shifting element (k_VA, k_HA_L, k_HA_R);
a drive moment of the electric motor (10) is transmitted through the gear train (11) to the drive converter (12), and the drive moment controls a control status of the drive-converter (12) which varies the power transfer capability of the shifting element (k_VA, k_HA_L, k_HA_R);
a working spring apparatus disengages the shifting element (k_VA, k_HA_L, k_HA_R) to implement the power transfer capability of the shifting element (k_VA, k_HA_L, k_HA_R), when the electric motor (10) is without operating power, and the power transfer capability of the shifting element (k_VA, k_HA_L, k_HA_R) is reduced; and
an interrupter device (27) is provided for retaining the drive-converter (12) in an active state in a predefined control condition.

14. The apparatus according to claim 13, wherein the interrupter device (27) is placed proximal to the electric motor (10) and, in the active state of the interrupter device (27), rotary movement of the electric motor (10) is prevented.

15. The apparatus according to claim 13, wherein an apparatus for stoppage is placed in an area of the transmission and, in an active condition thereof, prevents a rotary motion of a transmission gear train.

16. The apparatus according to claim 13, wherein the drive-converter (12) is designed as a spindle-spindle nut assembly and the interrupter device (27) for retaining, when in an active condition, communicates with a rotationally revolving component (14) of the drive-converter apparatus (12) such that a change of the control status of the shifting element (k_VA, k_HA_L, k_HA_R) is prevented.

17. The apparatus according to claim 13, wherein the interrupter device (27) is an electro-magnetic brake.

18. The apparatus according to claim 13, wherein the interrupter device (27) is an electromagnetic controllable, frictionally shape fit device that is brought into operative contact with a rotating component of one of the electric motor, the transmission, and the drive-converter.

19. The apparatus according to claim 13, wherein when a current supply is lacking, the interrupter device (27) is activated.

20. The apparatus according to claim 19, wherein the interrupter device (27) is operatively bound to a control member (28), by means of which the interrupter device (27) when in a state of no supply current, can be retained through an operative period in a deactivated condition.

21. The apparatus according to claim 13, wherein the electromagnetic brake is a friction fitting electromagnetically control brake.

22. A method of adjusting a power transfer capability of a frictionally based shifting element (k_VA, k_HA_L, k_HA_R) of a drive train (1) of a vehicle, the method comprising the steps of:
controlling the power transfer capability of the shifting element (k_VA, k_HA_L, k_HA_R) depending on a control state of a drive-converter (12) which is coupled to an electric motor (10) by a gear train (11);
converting rotary drive of the electric motor (10), via the drive-converter (12), into a translatory activation motion for the shifting element (k_VA, k_HA_L, k_HA_R); and
when the electric motor (10) is deprived of current and depending upon an operative state of the vehicle, the drive-converter (12), via an interrupter device (27), is prevented from further movement.

23. The method according to claim 22, further comprising the step of controlling a stopping action of the interrupter device (27) depending on an electronic time measurement such that the power transfer capability of the shifting element (k_VA, k_HA_L, k_HA_R), while being regulated by an existing disengaging behavior of the electric motor (10) deprived of current is established in accord with a current state of control of the vehicle.

24. The method according to claim 23, further comprising the step of providing a central driving dynamic regulator which creates a delay interval when considering an actual condition of the vehicle's presently existing power transfer capability of the shifting element (k_VA, k_HA_L, k_HA_R), and the delay interval activates the interrupter device (27) to stop, such that the shifting element (k_VA, k_HA_L, k_HA_R) is provided with a power transfer capability within a condition of the vehicle operation.

25. The method according to claim 23, further comprising the step of bringing the power transfer capability of the shifting element (k_VA, k_HA_L, k_HA_R) to a value, upon a call for activation of a parking-lock of a vehicle, and conducting a required torque to maintain a fixed position, over the shifting element (k_VA, k_HA_L, k_HA_R) and subsequently activating the interrupter device (27) for a delay period by the drive-converter apparatus (12) in which the established power transfer capability is continued.
